(19) United States
(12) Patent Application Publication
(10) Pub. No.: US 2005/0061899 A1
(43) Pub. Date: Mar. 24, 2005

(54) Grates for a comminution machine and methods of forming and assembling the same

(76) Inventor: Nelson C. Langworthy, Vestaburg, MI (US)

Correspondence Address: John D. Wright;Reising, Ethington, Barnes,, Kisselle & Learman, P.C., 5291 Colony Drive North, Saginaw, MI, 48603, US

(21) Appl. No.: 10/910,818

(22) Filed: Aug. 4, 2004

Related U.S. Application Data
(60) Provisional application No. 60/493,701, filed on Aug. 8, 2003.

(51) Int. Cl. B07C 7/00

(52) U.S. Cl. 241/260

(57) ABSTRACT

A grate assembly having at least two generally arcuate bodies and methods of forming and assembling the bodies of the grate assembly. Each body has an outer perimeter and a plurality of openings passing therethrough. At least a portion of the outer perimeter of each body has a perforate edge surface. The perforate edge surface is arranged for mating engagement with the perforate edge surface of an adjacent body to define at least some of the openings through which wood particulate passes.

This application claims the benefit of U.S. Provisional Application No. 60/493,701, filed Aug. 8, 2003.

### FIELD OF THE INVENTION

This invention relates generally to comminution machines, such as tub grinders, horizontal feed grinders, gravity fed grinders, or the like, and more particularly to grates for receiving material from hammer mills in a wood comminution machine wherein the grates determine the size of the particulate that is produced by the comminution machine.

### BACKGROUND OF THE INVENTION

It is known in the art to prepare ground wood product, commonly referred to as particulate or chips, having a predetermined particulate size utilizing tub grinders, horizontal feed grinders, and the like wherein a hammer mill rotates with a shaft to grind the wood between hammers on the hammer mill and a surface presenting an anvil. Typically, screens or grates having an arcuate shape are located beneath the hammer mill and have a plurality of openings that determine the ultimate size of the particulate that is produced by the machine. The openings are known to take on a variety of shapes and sizes, such as square, circular, triangular, hexagonal, octagonal, and so on. Typically, the overall grates span approximately 180 degrees, commonly requiring two or three removable abutting arcuate grates to span the 180 degrees. As shown in FIG. 1 of the prior art, the grates are commonly initially formed having a continuous imperforate flat frame 1 around an outer perimeter. Once bent to a curve, one of the perimetrical frames 1 of one grate 2 abuts another perimetrical frame 1 of a mating grate 3 to establish a seam 4 between the mating grates 2, 3. As a result, the seam 4 presents a continuous imperforate wall 5 that prevents throughput of ground particulate from the machine. Ultimately, by preventing or restricting throughput in the areas where abutting frame surfaces are created between mating grates, the potential throughput of ground particulate produced by the machine is reduced. To compensate for this, it is known to construct grates with webbing having a minimal material thickness in an attempt to provide either more openings or more open area within each opening, and thus, to gain more particulate throughput. Ultimately, a reduced web thickness reduces the useful life of the grates.

### SUMMARY OF THE INVENTION

A grate assembly constructed according to the present invention improves the throughput of wood particulate in a comminution apparatus. The grate assembly has at least two generally arcuate bodies, with each body having openings passing therethrough and having an outer perimeter. At least a portion of the outer perimeter of each body has a perforate edge surface. The perforate edge surface is arranged for mating engagement with the perforate edge surface of an adjacent body to define at least some of the openings through which wood particulate passes.

Another aspect of the invention includes forming a grate for a grate assembly including at least two of the grates and being used in a comminution apparatus that produces wood particulate. The steps include providing a sheet of steel having a predefined outer perimeter configuration and forming a plurality of openings having continuous peripheral surfaces through the sheet. Further, forming a discontinuous edge along at least a portion of the outer perimeter for mirrored mating engagement with another discontinuous edge on an abutting grate. Then, bending the sheet into a predefined arcuate shape.

Another aspect of the invention includes a method of assembling a grate assembly within a housing having curved support surfaces, the housing being part of a comminution machine that produces wood particulate. The steps include providing at least two generally arcuate rigid bodies each having a plurality of openings defined by continuous peripheral surfaces and an outer perimeter with at least one discontinuous edge surface. Further, placing at least two of the bodies in the housing in abutment with the curved surfaces and arranging the discontinuous edge surface of one of the bodies in mirrored mating engagement with the discontinuous edge surface of an adjacent one of the bodies to define a plurality enclosed openings between the adjacent bodies.

Some of the objects, features and advantages of the invention include a grate assembly that increases the amount of throughput of wood particulate in a comminution apparatus, provides an increased number of openings extending therethrough while having an increased lateral cross-sectional area through a webbing of each grate, improves the size consistency of the wood particulate, reduces the amount of material in constructing the grate assembly, reduces the overall weight of the grate assembly, is of relatively simple and economical design and manufacture and has an extended life in use.

### BRIEF DESCRIPTION OF THE DRAWINGS

These and other objects, features and advantages of this invention will become readily apparent from the following detailed description of the preferred embodiments and best mode, appended claims and accompanying drawings in which:

FIG. 1 is a plan view of a grate assembly before bending constructed according to the prior art;

FIG. 2 is a side elevation view of a tub grinder apparatus having a grate assembly constructed according to one presently preferred embodiment of the invention;

FIG. 3 is a view looking generally in the direction of arrow 3 in FIG. 2 showing a hammer mill;

FIG. 4 is a plan view of the grate assembly of FIG. 2 before bending;

FIG. 5 is an assembled perspective view of the grates with the hammer mill of FIG. 3 removed;

FIG. 6 is an enlarged fragmentary view showing mating surfaces of the grates taken generally along line 6-6 of FIG. 5; and

FIG. 7 is an enlarged fragmentary perspective view of the encircled area 7 of FIG. 4.

### DETAILED DESCRIPTION OF THE PREFERRED EMBODIMENTS

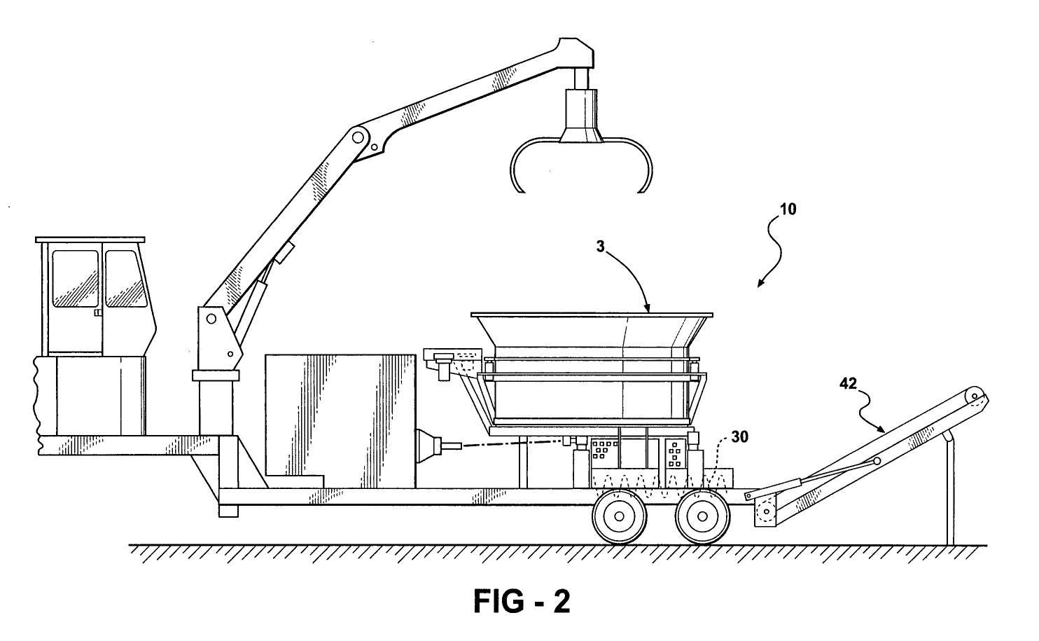

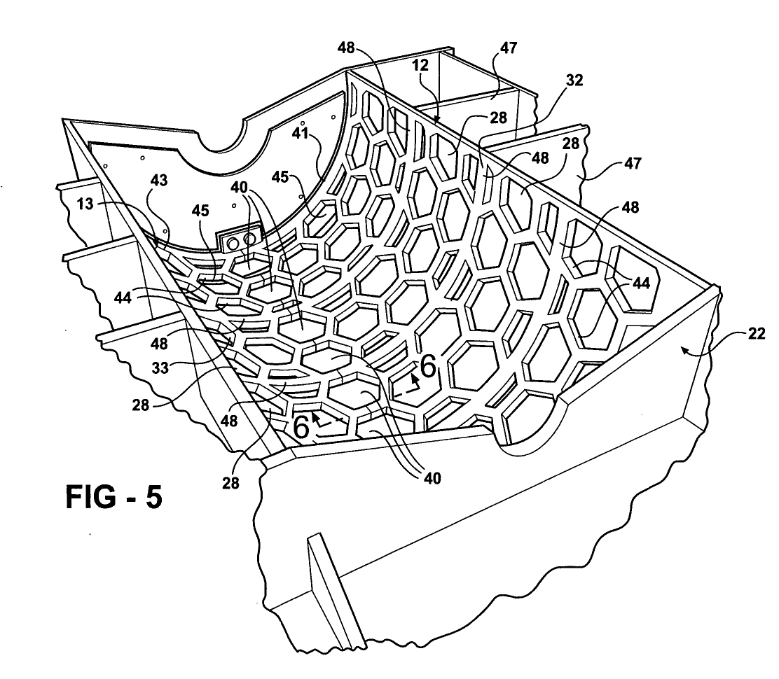

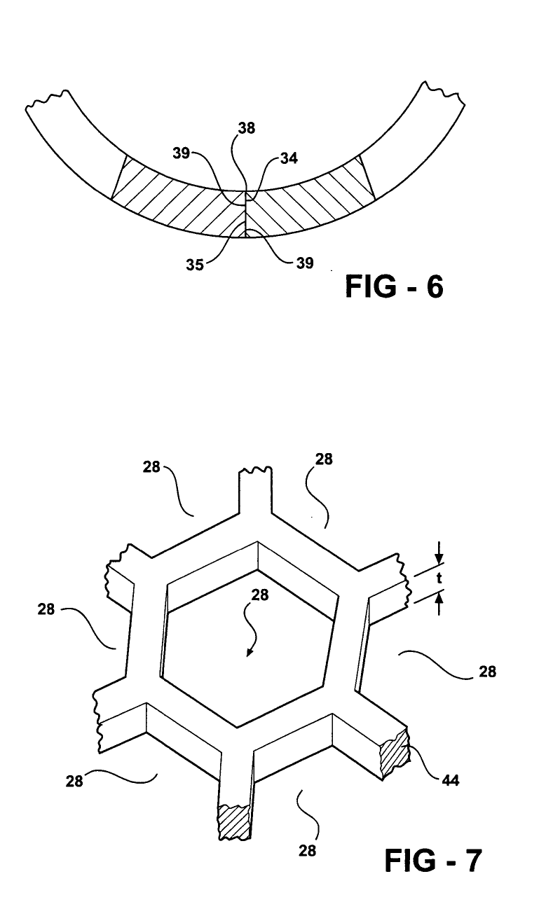

As shown in FIG. 2, a comminution apparatus, represented here as a tub grinder 10, has a pair of screens or grates 12, 13 (FIGS. 5 and 6) constructed according to one presently preferred embodiment. The grates 12, 13 facilitate the throughput of ground wood chips or particulate, and ultimately enhance the efficiency of producing ground particulate. It should be recognized that though the grates 12, 13 are shown in a tub grinder 10, that other comminution machinery may incorporate the grates 12, 13, for example and without limitation, horizontal feed grinders, gravity feed grinders, and the like, which is operative to reduce coarse or unground material to a smaller size finished material.

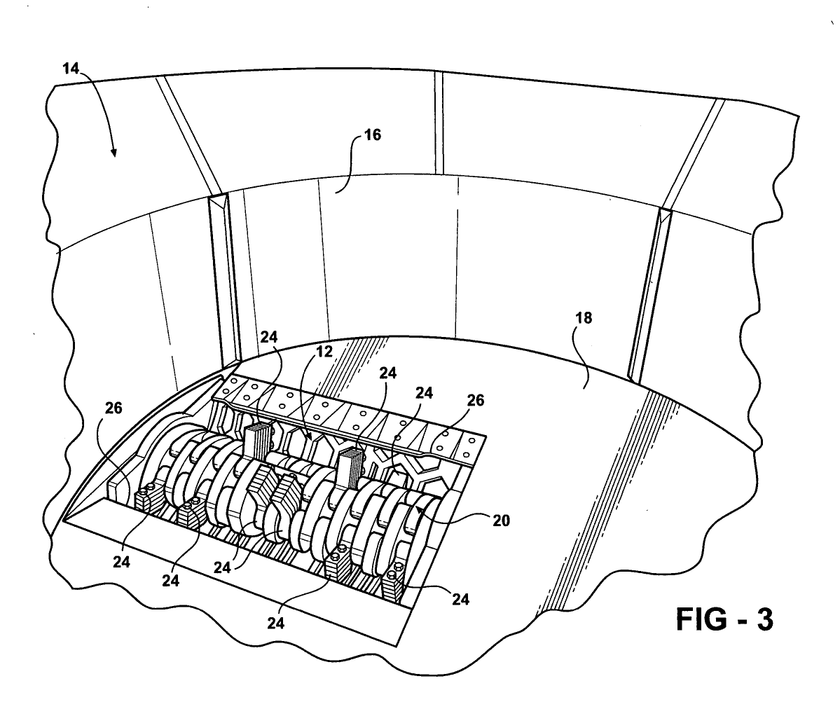

As shown in FIG. 3, a tub 14 of the tub grinder 10 has a generally cylindrical wall 16 that rotates relative to a stationary base or floor 18. As the wall 16 rotates, the unground wood material, commonly in the form of used pallets (not shown), in the tub 14 is caused to move in the direction of wall rotation. As the unground material rotates, it is urged into contact with a rotating hammer mill 20.

The hammer mill 20 is supported by an elongate shaft (not shown) within a housing 22 (FIG. 5) for rotation with the shaft. As the hammer mill 20 rotates, a plurality of hammers 24 forcefully engage the unground wood material to cut or pulverize the material against an anvil 26 (FIG. 3) typically supported by the floor 18 of the tub 14. Upon the material being cut, the material falls against the grates 12, 13, and the material that is of the desired finish size falls through openings 28 in the grates 12, 13 and onto a conveyor or auger 30 (FIG. 2). The material that is too large, and thus unable to fit through the openings 28 is re-circulated by the rotating hammer mill 20 so that it can be further cut until it is of the desired size, thereby allowing it to pass through the openings 28.

The grates 12, 13 are generally formed from a metallic material, and preferably are formed from steel. As best shown in FIG. 4, initially, the grates 12, 13 have a frame or body 32, 33 cut or stamped from a sheet of steel to define an outer perimeter 34, 35 of the bodies 12, 13, respectively. The bodies 32, 33 then have the openings 28 formed through the thickness of the bodies 32, 33. The openings 28 are preferably stamped or cut, such as by a laser, water jet, EDM, and the like, thereby defining webs or webbing 44 having a thickness (t) (FIG. 7) outlining a continuous peripheral surface of each opening 28. As shown in FIG. 4, the outer perimeters 34, 35 of the bodies 32, 33 have a pair of opposite ends 41, 43 terminating at a pair of opposite sides 36, 37, respectively. At least one of the sides 36, 37 of each body 32, 33 has a discontinuous or partly open perforate edge surface 39 for mating engagement with one another in use. Upon forming the openings 28 within the bodies 32, 33, the bodies 32, 33 are bent, preferably with the use of a press, to take on a predefined generally arcuate or curved mating shape (FIGS. 5 and 6). The independent arcuate bodies 32, 33 are supported at their ends 41, 43 in the machine on complimentarily curved support surfaces 45 on which they rest and from which they may be separately removed. Additionally, the bodies 32, 33 are shown supported along their length (L) by complimentarily curved support surfaces 47 between the ends 41, 43. Desirably, the bodies 32, 33 have solid imperforate ribs 48 for mating engagement and support against the support surfaces 47.

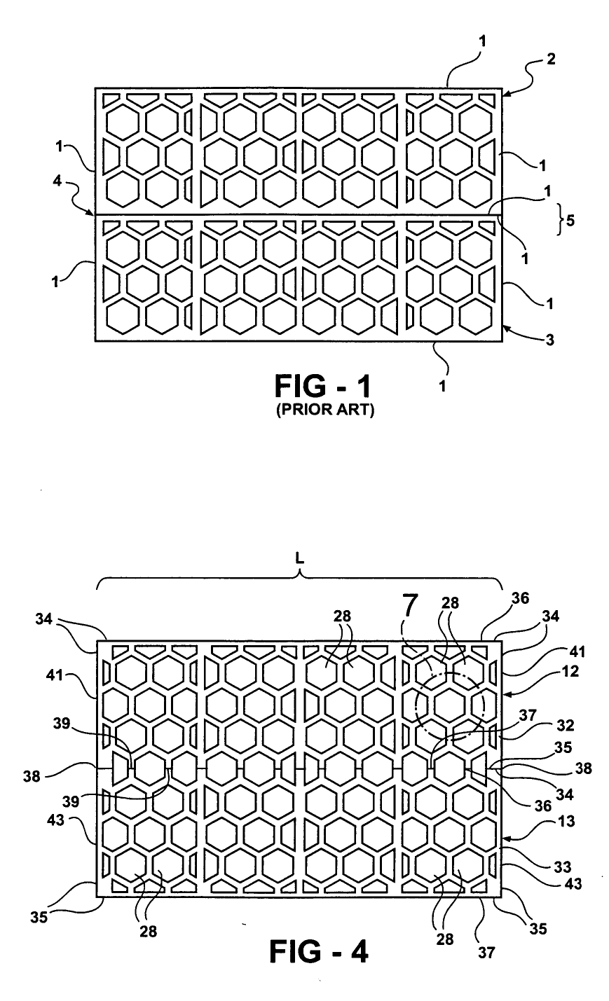

As best shown in FIG. 5, the grates 12, 13 in the tub grinder 10 typically span one-half of the entire grate surface. An enlarged view of the mating perforate edge surfaces 39 is shown in FIG. 6, better showing a discontinuous seam 38 being defined between the mating and preferably mirrored discontinuous edge surfaces 39 of the abutting bodies 32, 33. The mating perforate edge surfaces 39 generally mate across the thickness (t) and define openings 40 (FIG. 5) preferably similar in shape and size to the openings 28 throughout each grate 12, 13. As such, ground material or particulate of the desired size is free to pass through the composite openings 40 formed partly in each grate 12, 13 along the seam 38, thereby improving the efficiency in producing ground particulate. In the prior art, ground material is obstructed by the imperforate wall 5 formed by the mating imperforate edges (FIG. 1), thereby reducing the amount of ground material throughput of a comminution apparatus incorporating the prior art grates 2, 3. Upon the material passing through the grates 12, 13, it falls onto the pair of augers 30 preferably rotating in opposite directions so that the material is fed to a conveyor 42 (FIG. 2). The conveyor 42 then feeds the ground material into a pile or elsewhere for further use.

The bodies 32, 33 of the grates 12, 13 are preferably manufactured from a metallic material such as steel, wherein the openings 28, 40 are defined by a web 44 of steel (FIG. 7). Each opening 28, except for those at the mating perforate edge surfaces 39, is preferably formed as a fully enclosed opening by the web 44. The majority of the openings 28 are shown here having a generally hexagonal shape, though it should be understood that other geometries are equally suitable, such as triangular, rectangular, square, circular, or the like, as desired in the application.

In establishing the openings 40 along the seam 38, not only is the throughput of the ground material improved, but further design benefits can be achieved. For example, in having additional openings for ground material to pass through, the webs or webbing 44 surrounding each opening can be constructed having an increased cross-sectional thickness (t) without having to reduce the area presented by the openings 28 from that of the prior art, and thus the amount of throughput of ground material can be maintained. As such, the grates 12, 13 can be constructed having a more durable and long-lasting life in use. In addition, by eliminating the continuous edge 1 (FIG. 1), the grates 12, 13 can be constructed having a reduced material content, thereby reducing weight, and lowering the material cost of the grates 12, 13.

It is to be understood that other embodiments of invention which accomplish the same function are incorporated herein and are contemplated to be within the scope of any allowed claims. For example and without limitation, it should be recognized that shapes of the openings 28, 40 and sizes of the openings 28, 40 may be varied as desired to achieve the desired size of ground product. In addition, any number of grates may be constructed to abut one another, such as three mating grates commonly used in horizontal feed grinders. The invention is defined by the claims that follow.

1. A grate assembly for a comminution apparatus that produces wood particulate, comprising:
at least two generally arcuate rigid bodies each having a plurality of openings defined by continuous peripheral surfaces, said bodies having an outer perimeter with at least one discontinuous edge surface arranged for mating engagement with said discontinuous edge surface of an adjacent one of said bodies, said mating discontinuous edge surfaces defining a plurality enclosed openings between said mating bodies.

2. The grate assembly of claim 1 wherein a discontinuous seam is defined between said mating discontinuous edge surfaces.

3. The grate assembly of claim 1 wherein said assembly has an imperforate outer perimeter.

4. The grate assembly of claim 1 wherein said enclosed openings defined by said discontinuous edge surfaces are sized to allow ground particulate pass therethrough.

5. The grate assembly of claim 4 wherein said enclosed openings defined by said discontinuous edge surfaces are sized substantially the same as at least some of said openings defined by continuous peripheral surfaces.

6. A method of forming a grate for a grate assembly, the grate assembly including at least two of said grates and being used in a comminution apparatus that produces wood particulate, the steps comprising:
a. providing a sheet of steel having a predefined outer perimeter configuration;
b. forming a plurality of openings having continuous peripheral surfaces through said sheet;
c. forming a discontinuous edge along at least a portion of said outer perimeter, said discontinuous edge being formed for mirrored mating engagement with another discontinuous edge on an abutting one of said grates in the assembly; and
d. bending said sheet into a predefined arcuate shape.

7. The method of claim 6 wherein the forming step c) includes forming said discontinuous edge to define at least in part an opening when said discontinuous edge of one grate is placed in mating engagement with said discontinuous edge of another grate.

8. The method of claim 6 wherein the forming step c) includes forming said discontinuous edge to define at least in part a plurality of openings substantially the same size as at least some of the openings formed in step b) when said discontinuous edge of one grate is placed in mating engagement with said discontinuous edge of another grate.

9. A method of assembling a grate assembly within a housing having curved support surfaces, the housing being part of a comminution machine that produces wood particulate, the steps comprising:
providing at least two generally arcuate rigid bodies each having a plurality of openings defined by continuous peripheral surfaces, said bodies having an outer perimeter with at least one discontinuous edge surface;
placing said at least two bodies in said housing in abutment with said curved surfaces and arranging said discontinuous edge surface of one of said bodies in mirrored mating engagement with said discontinuous edge surface of an adjacent one of said bodies to define a plurality enclosed openings between said adjacent bodies.

10. The method of claim 9 wherein the placing step includes forming a discontinuous seam between said adjacent bodies.

11. The method of claim 10 including defining a plurality of enclosed openings along said discontinuous seam, the openings along said seam being substantially sized the same as said openings defined by the continuous surfaces.
